(19) United States
(12) Patent Application Publication
(10) Pub. No.: US 2023/0342701 A1
(43) Pub. Date: Oct. 26, 2023

(54) DELIVERY MANAGEMENT SERVER

(71) Applicant: NEC Corporation, Minato-ku, Tokyo (JP)

(72) Inventors: Rui ISHIYAMA, Tokyo (JP); Kengo MAKINO, Tokyo (JP)

(73) Assignee: NEC Corporation, Minato-ku, Tokyo (JP)

(21) Appl. No.: 17/797,174

(22) PCT Filed: Feb. 18, 2020
(86) PCT No.: PCT/JP2020/006325

§ 371 Date: Aug. 3, 2022

(51) Int. Cl. G06Q 10/083; G06K 19/08; G06V 10/74; G06T 7/60

(52) U.S. Cl. CPC G06Q 10/083; G06K 19/086; G06V 10/74; G06T 7/60

(57) ABSTRACT

A delivery management server, connected over a network to a user terminal used by a receiver who is a delivery destination of a delivery object or a carrier who delivers the delivery object, includes registration means for writing identification information of the delivery object and a first image in which a random pattern on a surface of the delivery object is captured, into a storage means in association with each other; matching means for performing matching between a second image in which a random pattern on a surface of the delivery object is captured, received from the user terminal, and the first image stored in the storage means; and confirmation recording means for, based on the matching result, recording, on the storage means, confirmation information that gives a confirmation that the user of the user terminal received the delivery object identified by the identification information associated with the first image.

### TECHNICAL FIELD

The present invention relates to a delivery management server, a delivery management method, and a storage medium.

### BACKGROUND ART

Conventionally, various delivery systems have been proposed and put into practice.

For example, Patent Literature 1 proposes a delivery system in which a parcel is not needed to be received face to face by using a dedicated parcel side device for accommodating a parcel to be delivered.

Patent Literature 2 proposes a delivery system in which in response to a parcel pickup and delivery request from a sender, candidate carriers apply for a contract of pickup and delivery of the parcel, and a carrier approved by the sender, among the applied candidate carriers, performs pickup and delivery of the parcel.

Patent Literature 3 proposes a system for realizing a flexible, sharing economy-type delivery service at low cost by combining a plurality of carriers who can deliver partial sections of the delivery section.

Patent Literature 4 proposes an anonymous delivery system in which a parcel can be delivered without informing personal information between a sender and a receiver of the parcel.
Patent Literature 1: JP 2019-159487 A
Patent Literature 2: JP 2018-133114 A
Patent Literature 3: JP 2018-200588 A
Patent Literature 4: JP 2017-167670 A

### SUMMARY

While various delivery systems have been proposed and put into practice conventionally as described above, it is difficult to simply and reliably obtain a confirmation that a carrier who delivers a delivery object or a receiver actually received the delivery object. For example, in Patent Literature 1, a dedicated parcel side device is used to obtain a confirmation that a carrier or a receiver actually received a delivery object. Further, in Patent Literatures 2 to 4, a slip sheet or a barcode is exchanged to obtain a confirmation that a carrier or a receiver actually received a delivery object.

An object of the present invention is to provide a delivery management server that solves the problem described above.

A delivery management server, according to one aspect of the present invention, is a delivery management sever connected to a user terminal over a network, the user terminal being used by a receiver who is a delivery destination of a delivery object or a carrier who delivers the delivery object. The server is configured to include
a registration means for writing identification information of the delivery object and a first image in which a random pattern on a surface of the delivery object is captured, into a storage means in association with each other,
a matching means for performing matching between a second image in which a random pattern on a surface of the delivery object is captured, received from the user terminal, and the first image stored in the storage means, and
a confirmation recording means for, on the basis of a result of the matching, recording, on the storage means, confirmation information that gives a confirmation that the user of the user terminal received the delivery object that is identified by the identification information associated with the first image.

Further, a delivery management method, according to another aspect of the present invention, is a delivery management method to be executed by a delivery management server connected to a user terminal over a network, the user terminal being used by a receiver who is a delivery destination of a delivery object or a carrier who delivers the delivery object. The method is configured to include
writing identification information of the delivery object and a first image in which a random pattern on a surface of the delivery object is captured, into a storage means in association with each other,
performing matching between a second image in which a random pattern on a surface of the delivery object is captured, received from the user terminal, and the first image stored in the storage means, and
on the basis of a result of the matching, recording, on the storage means, confirmation information that gives a confirmation that the user of the user terminal received the delivery object that is identified by the identification information associated with the first image.

Further, a computer-readable medium, according to another aspect of the present invention, is configured to store thereon a program for causing a computer constituting a delivery management server connected to a user terminal over a network, the user terminal being used by a receiver who is a delivery destination of a delivery object or a carrier who delivers the delivery object, to execute processing to
write identification information of the delivery object and a first image in which a random pattern on a surface of the delivery object is captured, into storage means in association with each other,
perform matching between a second image in which a random pattern on a surface of the delivery object is captured, received from the user terminal, and the first image stored in the storage means; and
on the basis of a result of the matching, record, on the storage means, confirmation information that gives a confirmation that the user of the user terminal received the delivery object that is identified by the identification information associated with the first image.

With the configurations described above, the present invention enables a confirmation that a carrier or a receiver actually received a delivery object to be obtained simply and reliably.

### BRIEF DESCRIPTION OF DRAWINGS

FIG. 1 is a block diagram of a delivery system according to a first exemplary embodiment of the present invention.

FIG. 2 is a block diagram of a delivery management server according to the first exemplary embodiment of the present invention.

FIG. 3 illustrates exemplary contents of a user DB in the delivery management server according to the first exemplary embodiment of the present invention.

FIG. 4 illustrates exemplary contents of a delivery request DB in the delivery management server according to the first exemplary embodiment of the present invention.

FIG. 5 illustrates exemplary contents of a carrier DB in the delivery management server according to the first exemplary embodiment of the present invention.

FIG. 6 illustrates exemplary contents of a storage place DB in the delivery management server according to the first exemplary embodiment of the present invention.

FIG. 7 illustrates exemplary contents of a delivery schedule DB in the delivery management server according to the first exemplary embodiment of the present invention.

FIG. 8 illustrates an example of a delivery request screen on a sender terminal according to the first exemplary embodiment of the present invention.

FIG. 9A illustrates an example of a random pattern drawn on a surface of a delivery object parcel according to the first exemplary embodiment of the present invention.

FIG. 9B illustrates an exemplary image of a random pattern captured by using a camera of a sender terminal according to the first exemplary embodiment of the present invention.

FIG. 10 illustrates an example of random pattern position information in the first exemplary embodiment of the present invention.

FIG. 11 illustrates a plane projection transformation expression.

FIG. 12 is a schematic diagram illustrating a relationship between an ellipse obtained when imaging a perfect circle drawn on a plane from an oblique direction and a square in internal contact with the original perfect circle.

FIG. 13 is a block diagram of a delivery management server according to a second exemplary embodiment of the present invention.

### EXEMPLARY EMBODIMENTS

Next, exemplary embodiments of the present invention will be described with reference to the drawings.

### First Exemplary Embodiment

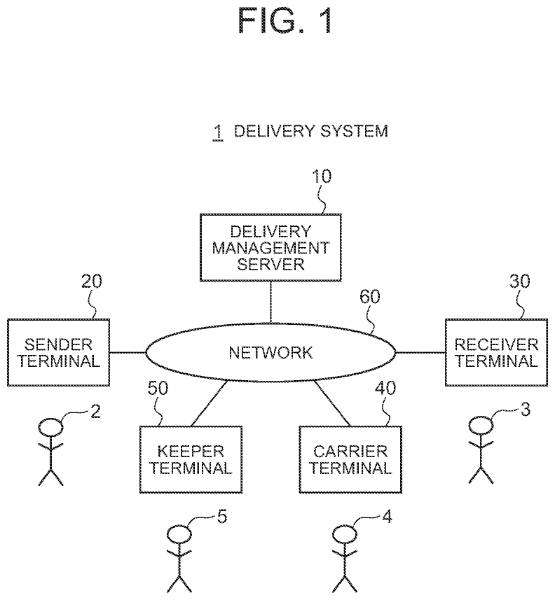

FIG. 1 is a block diagram of a delivery system 1 according to a first exemplary embodiment of the present invention. Referring to FIG. 1, the delivery system 1 includes a delivery management server 10, a sender terminal 20, a receiver terminal 30, a carrier terminal 40, and a keeper terminal 50 that are communicably connected with one another over a network 60 such as the Internet. In FIG. 1, the number of each of the delivery management servers 10, the sender terminals 20, the receiver terminals 30, the carrier terminals 40, and the keeper terminals 50 is only one. However, the number of each of them may be plural.

The sender terminal 20 is a terminal used by a user (sender 2) who sends a parcel. The receiver terminal 30 is a terminal used by a user (receiver 3) who receives a parcel. The carrier terminal 40 is a terminal used by a user (carrier 4) who delivers a parcel. The keeper terminal 50 is a terminal used by a user (keeper 5) who manages the place for temporarily storing a parcel. Each of the sender terminal 20, the receiver terminal 30, the carrier terminal 40, and the keeper terminal 50 is configured of, for example, an information processing terminal having a camera and a position detector, such as a smartphone, a tablet terminal, a personal computer (PC), or the like. The camera may be a visible-light color camera equipped with a charge-coupled device (CCD) image sensor or a complementary MOS (CMOS) image sensor having a pixel capacity of about several millions pixels, for example. The position detector may be a GPS sensor for example.

The delivery management server 10 is an information processing device that manages delivery of a parcel from the sender 2 to the receiver 3. The delivery management server 10 may be configured of a virtual server constructed on a server computer or a cloud computing service for example.

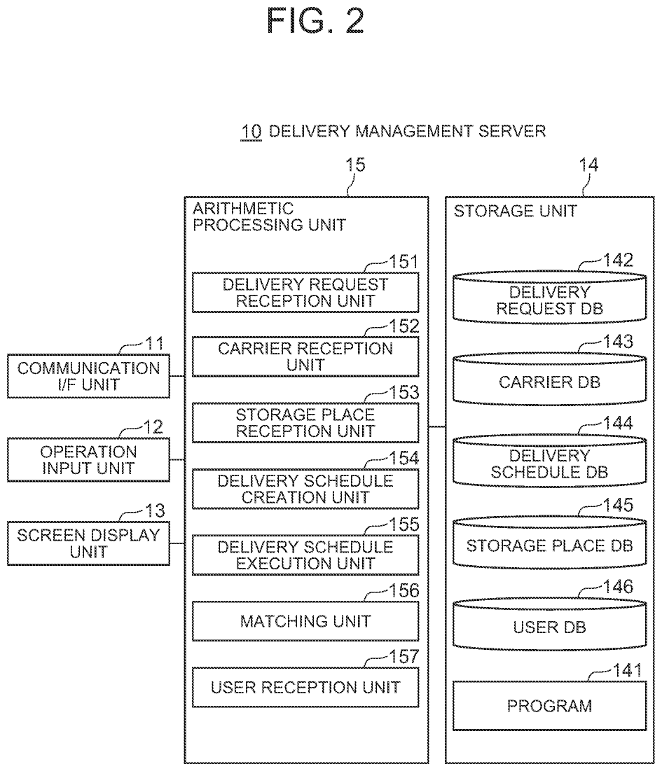

FIG. 2 is a block diagram of the delivery management server 10. Referring to FIG. 2, the delivery management server 10 includes a communication interface (UF) unit 11, an operation input unit 12, a screen display unit 13, a storage unit 14, and an arithmetic processing unit 15.

The communication I/F unit 11 is configured of a dedicated data communication circuit, and is configured to perform data communication with various devices connected over a wired or wireless network, such as the sender terminal 20, the receiver terminal 30, the carrier terminal 40, and the keeper terminal 50. The operation input unit 12 is configured of operation input devices such as a keyboard and a mouse, and is configured to detect operation by an operator and output it to the arithmetic processing unit 15. The screen display unit 13 is configured of a screen display device such as a liquid crystal display (LCD) or a plasma display panel (PDP), and is configured to display, on a screen, various types of information such as an operation menu according to an instruction from the arithmetic processing unit 15.

The storage unit 14 is configured of storage devices such as a hard disk and a memory, and is configured to store therein processing information and a program 141 necessary for various types of processing in the arithmetic processing unit 15. The program 141 is a program for implementing various processing units by being read and executed by the arithmetic processing unit 15, and is read in advance from an external device (not illustrated) or a storage medium (not illustrated) via a data input-output function such as the communication I/F unit 11 and is stored in the storage unit 14. The main processing information stored in the storage unit 14 includes a delivery request database (DB) 142, a carrier DB 143, a storage place DB 144, a delivery schedule DB 145, and a user DB 146.

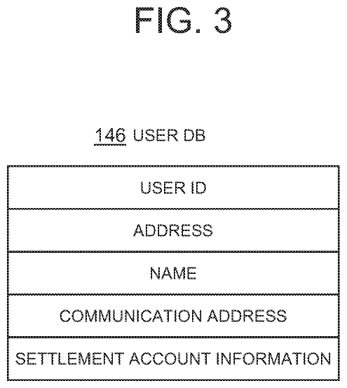

The user DB 146 is a database for storing therein information of the users such as the sender 2, the receiver 3, the carrier 4, and the keeper 5. FIG. 3 illustrates an exemplary configuration of user information stored in the user DB 146. In this example, the user information includes items such as a user ID, address, name, communication address, and settlement account information.

The item of user ID contains an ID that uniquely identifies a user. The items of address, name, and communication address contain information of the user's address, name, and communication address (email address or the like). The item of settlement account information contains information such as a credit card number for payment of a delivery fee and information such as a bank account for receiving a delivery fee and a storage fee.

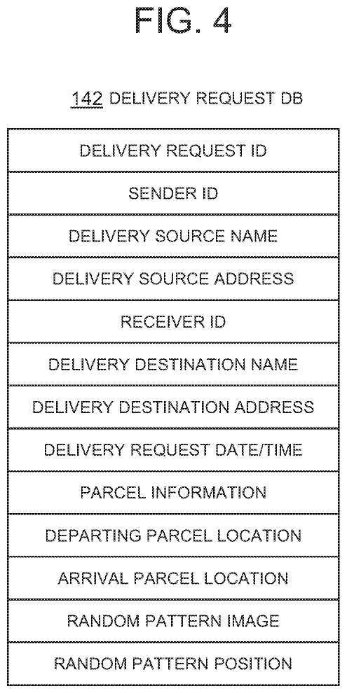

The delivery request DB 142 is a database for storing information about a delivery request received from the sender 2. FIG. 4 illustrates an exemplary configuration of delivery request information stored in the delivery request DB 142. In this example, the delivery request information includes items such as a delivery request ID, a sender ID, delivery source name, delivery source address, a receiver ID, delivery destination name, delivery destination address, delivery request date/time, parcel information, a departing parcel location, an arrival parcel location, a random pattern image, and a random pattern position.

The item of delivery request ID contains an ID that uniquely identifies a delivery request. The item of sender ID contains a user ID that uniquely identifies the sender 2 who requested the delivery. The items of delivery source name and the delivery source address contain information such as the name and the address of the delivery source, respectively. The item of receiver ID contains a user ID that uniquely identifies the receiver 3 that is the delivery destination. The items of delivery destination name and delivery destination address contain information such as the name and the address of the delivery destination, respectively. The item of delivery request date/time contains information of the delivery request date/time requested by the sender 2. The item of parcel information contains the content of a delivery object parcel requested by the sender 2, such as the type, size, and weight of the parcel. The item of departing parcel location contains information of the location where the delivery object parcel requested by the sender 2 is placed at the time of departure. The item of arrival parcel location contains information of the location where the delivery object parcel requested by the sender 2 is to be placed at the time of arrival. The departing parcel location and the arrival parcel location may be, for example, house, hotel, and the like that are specified by the address and the name of the delivery source and the delivery destination. Further, the departing parcel location and the arrival parcel location may be a storage place that is registered in the storage place DB 144.

The item of random pattern image contains an image in which a random pattern on a surface of a delivery object parcel, provided by the sender 2, is captured. In order to distinguish a delivery object parcel from other parcels, the sender 2 writes, by hand, a random pattern on a surface of the delivery object parcel by using a writing instrument such as a pen. The item of random pattern image contains an image in which a random pattern written by hand as described above is captured by a camera. The item of random pattern position contains information of the position where the random pattern is drawn on the parcel. Examples of information of the random pattern position include an image in which an image of the entire parcel with a random pattern and a line representing a bounding rectangle of the random pattern are synthesized, or text describing the position of the area on the parcel where the random pattern is drawn.

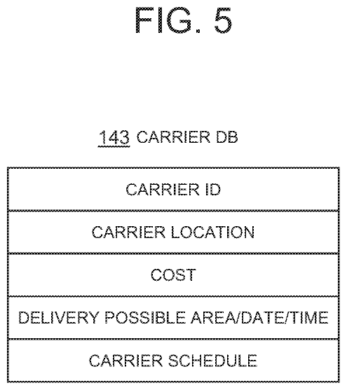

The carrier DB 143 is a database for storing information about a carrier received from the carrier 4. FIG. 5 illustrates an exemplary configuration of carrier information stored in the carrier DB 143. In this example, the carrier information is configured of items such as carrier ID, carrier location, cost, delivery possible area/date/time, and carrier schedule.

The item of carrier ID contains a user ID that uniquely identifies the carrier 4. The item of carrier location contains information of the location of the carrier 4. The location of the carrier 4 may be information of longitude, latitude, and height. The item of cost contains information of the parcel delivery cost. The delivery cost may be a cost per unit delivery distance for each parcel type, size, and weight, for example. The item of delivery possible area/date/time contains information of area and date/time where the carrier 4 can deliver the parcel. The information of delivery possible area may be a prefecture name and a city name, for example. The item of carrier schedule contains information about the schedule of the carrier 4.

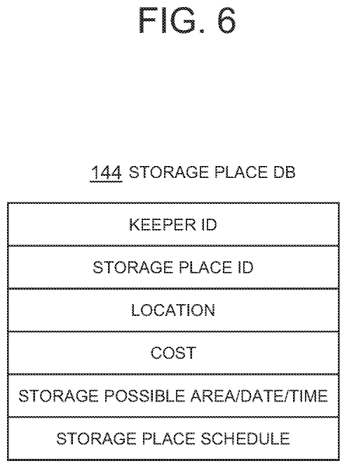

The storage place DB 144 is a database for storing information about the place where a delivery object parcel can be stored temporarily. The place where a delivery object parcel can be stored temporarily may be a convenience store, a person's house, a railway station, or the like that is registered in advance, for example. FIG. 6 illustrates an exemplary configuration of the information about the storage place stored in the storage place DB 144. In this example, the information about the storage place is configured of items such as a keeper ID, a storage place ID, location, cost, storage possible date/time, and storage place schedule.

The item of keeper ID contain a user ID that uniquely specifies a user who manages the storage place. The item of storage place ID contains an ID that uniquely identifies a storage place. The item of location contains information about the location of the storage place. The item of cost contains information about the parcel storage cost. The storage cost may be a cost per unit time for each parcel type, size, and weight, for example. The storage possible date/time contains information about the date/time that the storage place is available. The item of storage place schedule contains information about the schedule of the storage place.

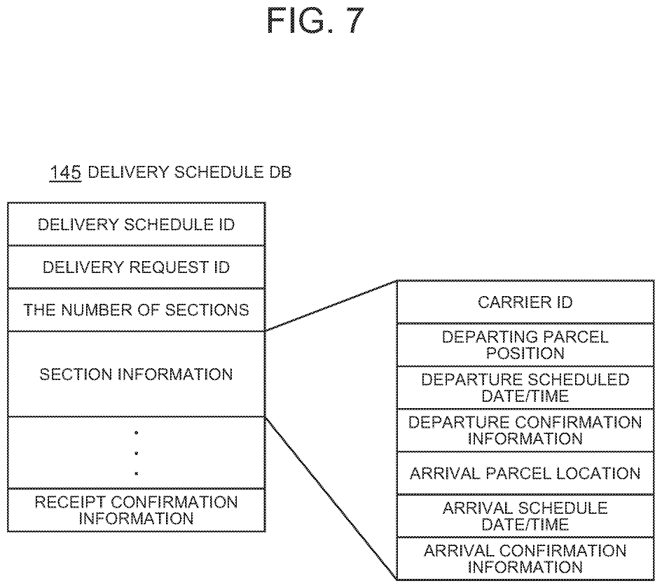

The delivery schedule DB 145 is a database for storing information about a delivery schedule of a parcel for each delivery request received from the sender 2. FIG. 7 illustrates an exemplary configuration of information about a delivery schedule stored in the delivery schedule DB 145. In this example, the information about the delivery schedule includes a delivery schedule ID, a delivery request ID, the number of sections, section information of each section, and receipt confirmation information.

The item of delivery schedule ID contains an ID that uniquely identifies a delivery schedule. The item of delivery request ID contains a delivery request ID that specifies a delivery request that is the basis for the delivery schedule. The item of the number of sections contains information indicating the number of subsections constituting the entire delivery section of the parcel. The item of section information corresponds to each subsection one to one, and contains information about a detailed delivery schedule for each subsection. The item of receipt confirmation information contains confirmation information that gives a confirmation that the receiver 3 actually received the delivered object. The confirmation information may be an image of a random pattern on a surface of the delivered object, captured by a camera of the receiver terminal 30. Alternatively, the confirmation information may be configured of such an image and some auxiliary data. The auxiliary data may be the capturing place, capturing date/time, and the like, for example. Alternatively, the auxiliary data may be exchangeable image file format (Exif) data.

Referring to FIG. 7, the item of section information is configured of items such as a carrier ID, a departure location, departure scheduled date/time, departure confirmation information, arrival location, arrival scheduled date/time, and arrival confirmation information.

The item of carrier ID contains a user ID of a carrier who delivers the parcel in the corresponding subsection. The items of departing parcel location and departure scheduled date/time contain information about the parcel location and the departure scheduled date/time at the starting point of the corresponding subsection, respectively. The item of departure confirmation information contains confirmation information giving a confirmation that the carrier 4 actually received the parcel to be delivered at the starting point of the corresponding subsection. The confirmation information may be an image of a random pattern on a surface of a parcel to be delivered, captured by a camera of the carrier terminal 40. Alternatively, the confirmation information may be such an image and the auxiliary data (capturing place, capturing date/time, and the like) as described above. The items of arrival parcel location and arrival scheduled date/time contain information of the parcel location and the arrival scheduled date/time at the end point of each subsection, respectively. The item of arrival confirmation information contains confirmation information giving a confirmation that the carrier 4 actually delivered the parcel to be delivered to the end point of the corresponding subsection. The confirmation information may be an image of a random pattern on a surface of a delivered parcel, captured by a camera of the carrier terminal 40. Alternatively, the confirmation information may be such an image and the auxiliary data (capturing place, capturing date/time, and the like) as described above.

The arithmetic processing unit 15 includes a microprocessor such as an MPU and the peripheral circuits thereof, and is configured to read and execute the program 141 from the storage unit 14 to allow the hardware and the program 141 to cooperate with each other to thereby implement the various processing units. The main processing units implemented by the arithmetic processing unit 15 include a delivery request reception unit 151, a carrier reception unit 152, a storage place reception unit 153, a delivery schedule creation unit 154, a delivery schedule execution unit 155, a matching unit 156, and a user reception unit 157.

The user reception unit 157 is configured to receive a registration request of a user who uses the delivery system from terminals such as the sender terminal 20, the receiver terminal 30, the carrier terminal 40, and the keeper terminal 50, and records user information on the user DB 146.

The delivery request reception unit 151 is configured to receive a parcel delivery request from the sender 2 via the sender terminal 20, and record the delivery request information on the delivery request DB 142.

The carrier reception unit 152 is configured to receive a carrier registration request from the carrier 4 via the carrier terminal 40, and record the carrier information on the carrier DB 143.

The storage place reception unit 153 is configured to receive a registration request of a storage place from the keeper 5 via the keeper terminal 50, and record the storage place information on the storage place DB 144.

The delivery schedule creation unit 154 is configured to determine, for each piece of delivery request information newly recorded on the delivery request DB 142, a carrier and a storage place to be assigned to the requested delivery on the basis of the carrier information recorded on the carrier DB 143 and the storage place information recorded on the storage place DB 144, and create a delivery schedule that is a delivery procedure.

The delivery schedule execution unit 155 is configured to manage the actual delivery procedure of the parcel on the basis of the delivery schedule recorded on the delivery schedule DB 145.

The matching unit 156 is configured to, by using an image in which a random pattern on a surface of a parcel to be delivered received from the sender terminal 20 as a reference image, perform matching between an image of a random pattern on a surface of a parcel to be delivered, received from the carrier terminal 40 or the receiver terminal 30, and the reference image.

Next, operation of the delivery system 1 according to the present embodiment will be described.

<User Registration>

A user who plans to use the delivery system 1 as the sender 2, the receiver 3, the carrier 4, or the keeper 5 connects to the user reception unit 158 of the delivery management server 10 in advance from each of the terminals 20, 30, 40, and 50 to transmit a user information registration request. The user information registration request includes the address, name, communication address, and settlement account information of the user. When the user reception unit 158 of the delivery management server 10 receives a user information registration request, the user reception unit 158 records the information included in the received registration request on the items of address, name, communication address, and settlement account information, respectively, creates user information in which newly adopted ID is recorded on the item of user ID, and registers it with the user DB 146. The user reception unit 158 also transmits a registration completion notice including the user ID to the terminal of the request source. When the terminal 20, 30, 40, or 50 of the request source receives a registration completion notice, the terminal stores the notified user ID, and displays on the terminal screen that registration of user information is completed. The notified user ID is used as an identifier for specify an individual when the user uses the delivery system 1 as the sender 2, the receiver 3, the carrier 4, or the keeper 5 by such a user.

<Registration of Carrier>

When the carrier 4 desires a parcel delivery job, the carrier 4 connects to the carrier reception unit 152 of the delivery management server 10 by the carrier terminal 40 in advance, and transmits a carrier information registration request. The carrier information registration request includes the carrier ID, location information of the carrier 4, cost information, and delivery possible area/date/time information. As the carrier ID, a user ID acquired through user registration by the carrier 4 is used. When the carrier reception unit 152 of the delivery management server 10 receives a carrier information registration request, the carrier reception unit 152 records such information on respective items of carrier ID, carrier location, cost, and delivery possible area/date/time, creates carrier information in which schedule information that is initialized not to include any registered schedule is recorded on the item of carrier schedule, and registers it with the carrier DB 143. The carrier reception unit 152 also transmits a registration completion notice to the carrier terminal 40. When the carrier terminal 40 receives a registration completion notice, the carrier terminal 40 displays the fact that registration of carrier information has been completed.

<Registration of Storage Place>

When the keeper 5 desires to provide a storage place for parcel delivery, the keeper 5 connects to the storage place reception unit 153 of the delivery management server 10 by the keeper terminal 50 in advance, and transmits a registration request for storage place information. The registration request for storage place information includes the keeper ID, location information of the storage place, cost information, and storage possible date/time information. As the keeper ID, a user ID acquired through user registration by the keeper 5 is used. When the storage place reception unit 153 of the delivery management server 10 receives a registration request for storage place information, the storage place reception unit 153 records such information on respective items of keeper ID, location, cost, and delivery possible date/time, creates storage place information in which schedule information that is initialized not to include any registered schedule is recorded on the item of storage place schedule, and registers it with the storage place DB 144. The storage place reception unit 153 also transmits a registration completion notice including the storage place ID to the keeper terminal 50. When the keeper terminal 50 receives a registration completion notice, the keeper terminal 30 stores therein the notified storage place ID, and displays on the terminal screen the fact that registration of the storage place information has been completed.

<Registration of Delivery Request>

The sender 2 who requests parcel delivery writes, by hand, a random pattern on a surface of the parcel by using a writing instrument such as a pen. Then, the sender 2 uses a camera of the sender terminal 20 to capture the random pattern image. Then, the sender 2 creates random pattern position information configured of a figure or text representing which part on the parcel the random pattern exists. Then, the sender 2 connects to the delivery request reception unit 151 of the delivery management server 10 from the sender terminal 20 to transmit delivery request information. The delivery request information includes information such as a sender ID, delivery source name, delivery source address, a receiver ID, delivery destination name, delivery destination address, delivery request date/time, parcel information, departing parcel location, arrival parcel location, a random pattern image, and a random pattern position.

As the sender ID, a user ID acquired through user registration by the sender 2 is used.

When the delivery request reception unit 151 of the delivery management server 10 receives delivery request information, the delivery request reception unit 151 records the information included therein on the respective items such as sender ID, delivery source name, delivery source address, receiver ID, delivery destination name, delivery destination address, delivery request date/time, parcel information, departing parcel location, arrival parcel location, random pattern image, and random pattern position, creates delivery request information in which a newly adopted ID is recorded on the item of delivery request ID, and registers it with the delivery request DB 142. The delivery request reception unit 151 also transmits a reception completion notice including the delivery request ID to the sender terminal 20. Upon receiving the reception completion notice, the sender terminal 20 stores therein the notified delivery request ID, and displays the fact that a parcel delivery request has been completed on the terminal screen. The delivery request reception unit 151 of the delivery management server 10 also transmits the delivery request ID whose reception has been completed to the delivery schedule creation unit 154.

<Creation of Delivery Schedule>

The delivery schedule creation unit 154 of the delivery management server 10 reads out the delivery request information including the delivery request ID whose reception has been completed from the delivery request DB 142, and creates a delivery schedule. The method of creating a delivery schedule is not limited particularly. However, the delivery schedule creation unit 154 may create a delivery schedule by a method as described below, for example.

First, the delivery schedule creation unit 154 extracts, from the carrier DB 143, the carrier 4 who can deliver a parcel from the departing parcel location to the arrival parcel location of the delivery request. That is, the delivery schedule creation unit 154 extracts, from among the pieces of carrier information stored in the carrier DB 143, all pieces of carrier information in which the departing parcel location and the arrival parcel location of the delivery request are included in the delivery possible area and the schedule is blank in the period up to the delivery request date/time. Then, the delivery schedule creation unit 154 creates a delivery schedule for the extracted carrier information one to one. A delivery schedule created in this way is referred to as a non-relay delivery schedule.

In the delivery schedule information according to a non-relay delivery schedule, the item of the number of sections in FIG. 7 is filled with 1, and a piece of section information is created. Further, in the section information, the item of carrier ID is filled with the ID of the extracted carrier 4, the item of departing parcel location is filled with the departing parcel location in the delivery request information, the item of departure scheduled date/time is filled with the current date/time or date/time that is sometime after the current time, the item of arrival parcel location is filled with the arrival parcel location in the delivery request information, and the item of arrival scheduled date/time is filled with the delivery request date/time in the delivery request information or date/time that is sometime before it, respectively. The remaining items of the section information, that is, departure confirmation information and arrival confirmation information, are fill with NULL at the time of creating the delivery schedule. The item of receipt confirmation information is also filled with NULL.

The delivery schedule creation unit 154 also extracts, from the storage place DB 144, a storage place that can be a relay point between the departing parcel location and the arrival parcel location in the delivery request. That is, the delivery schedule creation unit 154 extracts, from among the pieces of storage place information stored in the storage place DB 144, all pieces of storage place information in which the place is geographically located between the departing parcel location and the arrival parcel location in the delivery request information and the schedule is blank in the period up to the delivery request date/time in the delivery request information. Then, the delivery schedule creation unit 154 divides the entire delivery section of the parcel into some subsection, that is, from the delivery schedule in the delivery request information to a storage place, from the storage place to the next storage place, and such a storage place to the arrival parcel location in the delivery request information, and extracts, from the carrier DB 143, the carrier 4 that can deliver the parcel for each subsection. Then, the delivery schedule creation unit 154 creates a plurality of delivery schedules for delivering the parcel in a relay system by combining a plurality of extracted carriers 4. The delivery schedules created in this manner are referred to as relay delivery schedules.

In the delivery schedule information according to the relay delivery schedules, the item of the number of sections in FIG. 7 is filled with a value of 2 or larger, and pieces of section information corresponding to the number of sections are created. Further, in one section information, the item of carrier ID is filled with the ID of the carrier 4 in charge of the delivery section, the item of departing parcel location is filled with the departing parcel location at the starting point of the delivery section (departing parcel location in the delivery request information or storage place), the item of departure scheduled date/time is filled with the departure scheduled date/time, the item of arrival parcel location is filled with the arrival parcel location of the delivery section (storage place or arrival parcel location in the delivery request), and the item of arrival scheduled date/time is filled with the arrival scheduled date/time of the delivery section, respectively. The remaining items of the section information, that is, departure confirmation information and arrival confirmation information, are filled with NULL at the time of creating the delivery schedule. The item of receipt confirmation information is also filled with NULL.

Then, for each of the created delivery schedules, the delivery schedule creation unit 154 calculates the total cost of the entire delivery schedules on the basis of the cost of the carriers and the cost of the storage places to be used. Then, the delivery schedule creation unit 154 determines a delivery schedule in which the total cost is the lowest to be a delivery schedule to be used actually. Then, the delivery schedule creation unit 154 records the information of the determined delivery schedule on the delivery schedule DB 145, and transmits the delivery schedule ID to the delivery schedule execution unit 155. Further, the delivery schedule creation unit 154 updates the carrier DB 143 and the storage place DB 144 in order to register the schedule assigned in the delivery schedule with the schedules of the carrier and the storage place assigned in the determined delivery schedule.

<Delivery Schedule Execution>

The delivery schedule execution unit 155 of the delivery management server 10 reads out the delivery schedule information including the delivery schedule ID transmitted from the delivery schedule creation unit 154 from the delivery schedule DB 145, and focuses on the readout delivery schedule information. Then, the delivery schedule execution unit 155 executes the delivery schedule in accordance with the focused delivery schedule information. Specifically, the delivery schedule execution unit 155 performs the processing described below.

First, the delivery schedule execution unit 155 extracts the delivery request ID from the focused delivery schedule information, and by using the extracted delivery request ID as a key, extracts delivery request information, serving as the basis, from the delivery request DB 142, and focuses on the extracted delivery request information. Then, the delivery schedule execution unit 155 extracts parcel information (type, size, weight, and the like of the parcel), a random pattern image, and random pattern position information, from the focused delivery request information.

Then, the delivery schedule execution unit 155 focuses on the first section information in the focused delivery schedule information. Then, the delivery schedule execution unit 155 extracts the carrier ID, the departing parcel location, and the departure scheduled date/time, from the focused section information. Then, the delivery schedule execution unit 155 acquires a communication address of the carrier from the carrier DB 143 by using the extracted carrier ID as a key. Then, the delivery schedule execution unit 155 transmits first delivery information to the carrier terminal 40 by using the acquired communication address. The first delivery information includes parcel information (type, size, weight, and the like of the parcel), the departing parcel location, the departure scheduled date/time, and the random pattern position information. Then, the delivery schedule execution unit 155 waits for carrier start information to be transmitted from the carrier terminal 40.

When the carrier terminal 40 receives the first delivery information transmitted from the delivery schedule execution unit 155, the carrier terminal 40 displays it on the terminal screen to notify the carrier 4. Upon confirmation of the display content, the carrier 4 can recognize the type, size, and weight of the parcel that the carrier is requested to deliver, the departing parcel location, the departure scheduled date/time, the position of the random pattern on the parcel, and the like. The carrier 4 moves to the designated departing parcel location by the designated departure scheduled date/time, confirms the parcel to be delivered, and captures an image of the random pattern on the parcel by using a camera of the carrier terminal 40. The carrier terminal stores the image, captured by the camera, in the memory of the terminal, along with the auxiliary data such as the capturing location information measured by the GPS sensor and the capturing date/time information. Then, the carrier 4 transmits the carrier start information including the carrier ID and the random pattern image and the auxiliary data stored in the carrier terminal 40, from the carrier terminal 40 to the delivery schedule execution unit 155 of the delivery management server 10.

When the delivery schedule execution unit 155 receives the carrier start information from the carrier terminal 40, the delivery schedule execution unit 155 checks whether or not the carrier ID included in the carrier start information coincides with the carrier ID in the focused section information, and when they coincide with each other, transmits, to the matching unit 156, the random pattern image included in the carrier start information as a matching image and the random pattern image acquired from the focused delivery request information as a reference image, and requests matching. When the carrier ID included in the carrier start information does not coincide with the carrier ID of the focused section information, the delivery schedule execution unit 155 transmits an error message to the transmission source. The matching unit 156 performs matching between the reference image and the matching image, and returns the matching result to the delivery schedule execution unit 155. When the matching result is a success (match), the delivery schedule execution unit 155 records the random pattern image and the auxiliary data included in the received carrier start information as departure confirmation information, on the item of departure confirmation information of the focused section information. Then, the delivery schedule execution unit 155 acquires information of the arrival parcel location and the arrival scheduled date/time of the delivery object from the focused section information, and transmits second delivery information including such information to the carrier terminal 40. Then, the delivery schedule execution unit 155 waits for carrier end information transmitted from the carrier terminal 40. Meanwhile, when the matching result is a failure (mismatch), the delivery schedule execution unit 155 transmits an error message to the carrier terminal 40 and requests it to transmit carrier start information again.

When the carrier terminal 40 receives the second delivery information including the arrival parcel location and the arrival scheduled date/time of the delivery object or an error message transmitted from the delivery schedule execution unit 155, the carrier terminal 40 displays it on the terminal screen to notify it to the carrier 4. When receiving an error message, the carrier 4 repeats the same operation as that described above until second delivery information can be received. Further, upon receiving the second delivery information, the carrier 4 delivers the delivery object in accordance with the information of the arrival parcel location and the arrival scheduled date/time included in the second delivery information. That is, the carrier 4 delivers the delivery object to the arrival parcel location by the designated arrival scheduled date/time.

Upon completion of delivery of the delivery object to the arrival parcel location, the carrier 4 captures the image of the random pattern on the parcel by using the camera of the carrier terminal 40. The carrier terminal 40 stores the image, captured by the camera, in the memory of the terminal, along with the auxiliary data such as the capturing location information measured by the GPS sensor and the capturing date/time information. Then, the carrier 4 transmits the carrier end information including the carrier ID and the random pattern image and the auxiliary data stored in the carrier terminal 40, from the carrier terminal 40 to the delivery schedule execution unit 155 of the delivery management server 10.

When the delivery schedule execution unit 155 receives the carrier end information from the carrier terminal 40, the delivery schedule execution unit 155 checks whether or not the carrier ID included in the carrier end information coincides with the carrier ID in the focused section information, and when they coincide with each other, transmits, to the matching unit 156, the random pattern image included in the carrier end information as a matching image and the random pattern image acquired from the focused delivery request information as a reference image, and requests matching. When the carrier ID included in the carrier end information does not coincide with the carrier ID of the focused section information, the delivery schedule execution unit 155 transmits an error message to the transmission source. The matching unit 156 performs matching between the reference image and the matching image, and returns the matching result to the delivery schedule execution unit 155. When the matching result is a success (match), the delivery schedule execution unit 155 records the random pattern image and the auxiliary data included in the received carrier end information as arrival confirmation information on the item of arrival confirmation information of the focused section information. Then, the delivery schedule execution unit 155 transmits an end message to the carrier terminal 40. Meanwhile, when the matching result is a failure (mismatch), the delivery schedule execution unit 155 transmits an error message to the carrier terminal 40 and requests it to transmit carrier end information again.

When the carrier terminal 40 receives an end message or an error message transmitted from the delivery schedule execution unit 155, the carrier terminal 40 displays it on the terminal screen to notify the carrier 4. When receiving an error message, the carrier 4 repeats the same operation as that described above until it receives an end message. When receiving an end message, the carrier 4 ends the requested delivery.

When the delivery schedule execution unit 155 transmits an end message to the carrier terminal 40 for the focused section information, if there is next section information in the focused delivery schedule information, the delivery schedule execution unit 155 moves the focus to the next section information, and repeats the same processing as the processing performed on the previous section information. If there is no next section information, it means that the delivery object has reached the arrival parcel location in the focused delivery request information.

When the delivery schedule execution unit 155 transmits an end message to the carrier terminal 40 of the last delivery section, the delivery schedule execution unit 155 acquires the receiver ID from the focused delivery request information. Then, the delivery schedule execution unit 155 acquires a communication address of the receiver terminal 30 from the user DB 146 by using the acquired receiver ID as a key. Then, the delivery schedule execution unit 155 transmits the delivery completion information to the receiver terminal 30 by using the acquired communication address. The delivery completion information includes parcel information (type, size, weight, and the like of the parcel), the arrival parcel location, the arrival date/time (capturing date/time in the last arrival confirmation information), and the random pattern position information. Then, the delivery schedule execution unit 155 waits for receipt information transmitted from the receiver terminal 30.

When the receiver terminal 30 receives delivery completion information transmitted from the delivery schedule execution unit 155, the receiver terminal 30 displays the parcel information, the arrival parcel location, the arrival date/time, and the random pattern position included in the delivery completion information, on the terminal screen to notify the receiver 3. Upon confirmation of the display content, the receiver 3 can recognize the type, size, and weight of the delivered parcel, the arrival parcel location, the arrival date/time, and the position of the random pattern on the parcel. The receiver 3 confirms the parcel at the designated arrival location, and captures the image of the random pattern on the parcel by using the camera of the receiver terminal 30. The receiver terminal 30 stores the image, captured by the camera, in the memory of the terminal, along with the auxiliary data including the capturing location information measured by the GPS sensor and the capturing date/time information. Then, the receiver 3 transmits the receipt information including the receiver ID and the random pattern image and the auxiliary data stored in the receiver terminal 30, to the delivery schedule execution unit 155 of the delivery management server 10.

When the delivery schedule execution unit 155 receives the receipt information from the receiver terminal 30, the delivery schedule execution unit 155 checks whether or not the receiver ID included in the receipt information coincides with the receiver ID of the focused delivery request information, and when they coincide with each other, transmits, to the matching unit 156, the random pattern image included in the receipt information as a matching image and the random pattern image acquired from the focused delivery request information as a reference image, and requests matching. When the receiver ID included in the receipt information does not coincide with the receiver ID in the focused delivery request information, the delivery schedule execution unit 155 transmits an error message to the transmission source. The matching unit 156 performs matching between the reference image and the matching image, and returns the matching result to the delivery schedule execution unit 155. When the matching result is a success (match), the delivery schedule execution unit 155 records the random pattern image and the auxiliary data included in the received receipt information as receipt confirmation information, on the item of receipt confirmation information of the focused delivery schedule information. Then, the delivery schedule execution unit 155 transmits an end message to the receiver terminal 30. Meanwhile, when the matching result is a failure (mismatch), the delivery schedule execution unit 155 transmits an error message to the receiver terminal 30 and requests it to transmit receipt information again.

When the receiver terminal 30 receives an end message or an error message transmitted from the delivery schedule execution unit 155, the receiver terminal 30 displays it on the terminal screen to notify the receiver 3. When receiving an error message, the receiver 3 repeats the same operation as that described above until it receives an end message.

Further, when the delivery schedule execution unit 155 transmits an end message to the receiver terminal 30, the delivery schedule execution unit 155 charges the sender 2 for the delivery fee on the basis of the costs of the carrier and the storage place used in the focused delivery schedule information, and pays the delivery fee and the storage fee to the carrier 4 and the keeper 5. Then, the delivery schedule execution unit 155 executes the delivery schedule in accordance with the focused delivery schedule information.

Next, registration of a delivery request will be described in more detail.

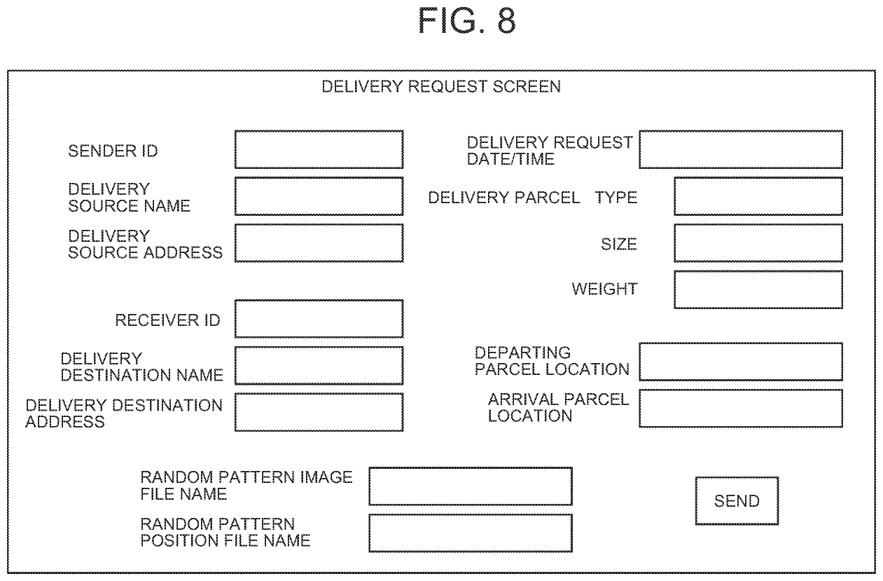

FIG. 8 illustrates an example of a delivery request screen of the sender terminal 20. In this example, the delivery request screen includes input boxes for a sender ID, delivery source name, delivery source address, a receiver ID, delivery destination name, delivery destination address, delivery request date/time, type, size, and weight of a delivery parcel, departing parcel location, arrival parcel location, a random pattern image file name, and a random pattern location file name. The sender 2 fills in the input boxes with necessary information to create delivery request information.

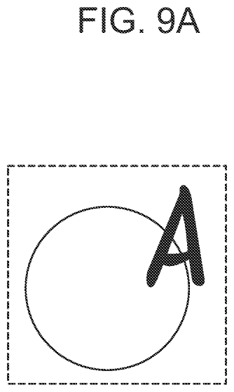

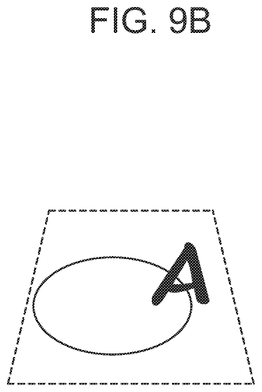

FIG. 9A illustrates an example of a random pattern drawn by the sender 2 on a surface of a parcel to be delivered. In this example, the random pattern is configured of a rectangle drawn by a broken line, a perfect circle drawn by a solid line within the rectangle, and a character “A” in boldface written by hand at the upper right side of the perfect circle. The sender 2 may draw such a random pattern directly on a surface of a delivery object by using a commercially available ink pen, or may draw it on a sheet attached to the delivery object. In the case where there is any pattern or flaw on a surface of the delivery object or on a sheet before a random pattern is drawn, such a pattern or a flaw forms a part of the random pattern.

FIG. 9B illustrates an exemplary image of a random pattern captured by using a camera of the sender terminal 20 by the sender 2. FIG. 9B illustrates an image in which the random pattern in FIG. 9A is captured from an oblique direction, which differs from the image of FIG. 9A because it is affected by distortion caused by projection. The captured image of the random pattern is recorded as an image file on the memory of the sender terminal 20. In addition, auxiliary data such as the current position of the sender terminal 20 and the current time is recorded on the image file.

The input box for a random pattern image file name on the delivery request screen of FIG. 8 is filled with a file name of an image file on which an image of a random pattern as described above is recorded. The sender 2 also creates a file describing an image or text indicating in which area of the delivery object the random pattern of FIG. 9A is drawn, and inputs the file name into the input box for the random pattern position file name.

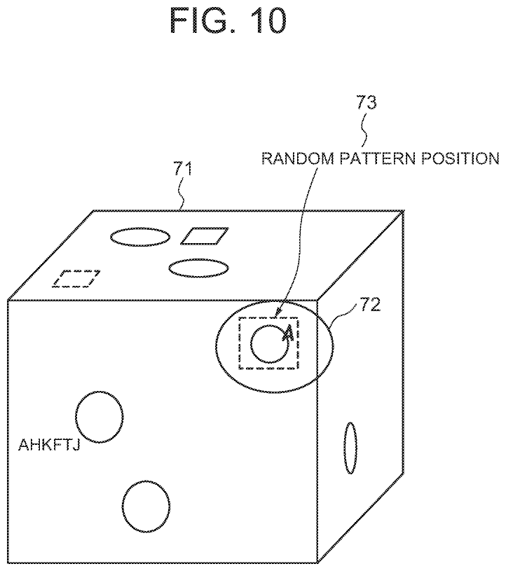

FIG. 10 illustrates an example of random pattern position information. The random pattern position information of this example is an image file in which a mark 72 in a circle shape indicating the random pattern position and description text 73 are synthesized in an image in which the outer appearance of a parcel 71 is captured. On the parcel 71, a plurality of patterns are drawn besides the random pattern. The mark 72 and the text 73 are used to allow a third party to recognize which pattern at which position on the parcel is an authorized random pattern. Further, the random pattern position information is transmitted only to an authorized user. Therefore, it is difficult for a person who is not an authorized user to recognize an authorized random pattern even if he/she comes into contact with the parcel 71.

After the sender 2 inputs necessary information, when the sender 2 clicks the transmission button on the delivery request screen, the sender terminal 20 transmits the created delivery request information to the delivery request reception unit 151 of the delivery management server 10 over the network 60.

When receiving the delivery request information, the delivery request reception unit 151 performs the processing described below before registering with the delivery request DB 142. (a) Correction of distortion caused by projection of a random pattern image (b) Confirmation of random property (confirmation of discernment of a random pattern)

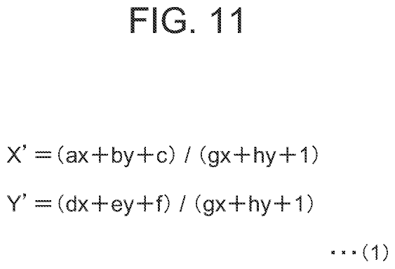

First, correction of distortion caused by projection of a random pattern image will be described. As described with reference to FIG. 9A, a random pattern includes a perfect circle. Therefore, the delivery request reception unit 151 detects an ellipse corresponding to the perfect circle from the random pattern image, and performs projection transformation on the random pattern image such that the detected ellipse becomes a perfect circle to thereby correct the distortion caused by the projection of the random pattern image. Specifically, in general, plane projection transformation is expressed by Expression 1 shown in FIG. 11. In Expression 1, x and y represent coordinates before transformation, x′ and y′ represent coordinates after transformation, and a, b, c, d, e, f, g, and h represent projection transformation coefficients. In order to obtain these eight projection transformation coefficients, the delivery request reception unit 151 solves a simultaneous equation with eight unknown in which coordinates of four points before and after the transformation are substituted in Expression 1. That is, an ellipse is detected from the image, and the coordinates of the four points before and after the transformation on the detected ellipse are substituted in Expression 1 to thereby calculate projection transformation coefficients. As the four points, four vertexes of the square in internal contact with the source circle are used.

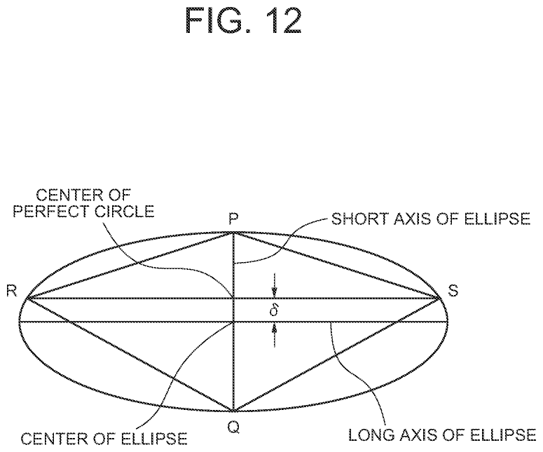

FIG. 12 is a schematic diagram illustrating a relationship between an ellipse obtained when imaging a perfect circle drawn on a plane from an oblique direction and a square in internal contact with the source perfect circle. The square in internal contact with the source perfect circle is a square in which two vertexes P and Q, facing each other, coincide with both end points of a short axis of the ellipse. At that time, the remaining two vertexes R and S of the square do not coincide with both end points of a long axis of the ellipse. This is because the center of an ellipse when viewed from an oblique direction does not generally coincide with the center of the source circle. That is, the center of the source perfect circle moves in a depth direction of the short axis by a distance S.

Therefore, the delivery request reception unit 151 calculates contact points where a line, running through an intersection point between the vanishing line on the image and an extended line of the short axis of the ellipse, is in contact with the ellipse, as the vertexes R and S.

Alternatively, the delivery request reception unit 151 handles the distance δ between the center of the ellipse when the circle is viewed from the oblique direction and the center of the source circle as a variable that depends on the feature amount of the ellipse (for example, eccentricity or oblateness), and calculates in advance by means of a statistical method for various ellipses having different feature amounts, and stores them in a correspondence table. The delivery request reception unit 151 also acquires the distance δ corresponding to the feature amount of an ellipse matching the feature amount of the ellipse in the random pattern image, from the correspondence table. Then, the delivery request reception unit 151 calculates two intersection points between a line, running through a point separated from the center of the ellipse by the distance δ in the depth direction of the short axis of the ellipse and is parallel to the long axis of the ellipse, and the ellipse, as the vertexes R and S.

Then, the delivery request reception unit 151 uses the coordinate values before and after the projection transformation of a square in which the four points are vertexes, to calculate projection transformation coefficients for projection transformation. Then, the delivery request reception unit 151 uses the calculated projection transformation coefficients to perform projection transformation on the entire random pattern image to generate a random pattern image without any projection distortion. A random pattern image without any projection distortion, generated as described above, is referred to as a random pattern image to be registered.

Next, confirmation of the random property will be described. The delivery request reception unit 151 calculates matching scores indicating the similarities between the random pattern image to be registered and the random pattern images in all of the other delivery request information having been registered in the delivery request DB 142. Then, when the maximum value of the matching scores is equal to or larger than a threshold, since the random pattern image to be registered is undistinguishable from the other random pattern images having been registered, the delivery request reception unit 151 discards the random pattern image to be registered. On the other hand, when the maximum value of the matching scores is smaller than a threshold, since the random pattern image to be registered is clearly distinguishable from the other random pattern images having been registered, the delivery request reception unit 151 adopts the random pattern image as an image to be registered with the delivery request DB 142.

When the delivery request reception unit 151 discards the random pattern image to be registered, since the random property of the random pattern image is insufficient, the delivery request reception unit 151 transmits, to the sender terminal 20, a message to prompt creation of another random pattern by adding a character or the like and execution of a registration operation again. The sender terminal 20 receives this message and displays it on the terminal screen.

Registration of a delivery request has been described above in more detail. However, correction of distortion caused by projection of a random pattern image is not limited to the time of registering a delivery request. The delivery schedule execution unit 155 of the delivery management server 10 may be configured to, when receiving a random pattern image on a delivery object from the carrier terminal 40 and the receiver terminal 30, correct the distortion caused by projection of the random pattern image by the same method as described above and perform matching between the corrected random pattern image and a reference image.

As described above, according to the present embodiment, it is possible to associate a parcel and destination information such as delivery destination with each other without attaching, to a delivery object, a label on which the destination information such as an address and the name of the delivery destination is described. This is because the parcel and the destination information are associated with each other via an image of a random pattern drawn on the parcel.

Further, according to the present embodiment, since it is unnecessary to attach a label on which the destination information is described to the parcel, the sender 2 can easily make a parcel sending request anywhere at any time.

Further, according to the present embodiment, since it is unnecessary to attach a label on which the destination information is described to a parcel, it is possible to physically conceal the private information such as a delivery destination so as to protect the personal privacy.

Further, according to the present embodiment, when carrier start information including the carrier ID and a random pattern image on a parcel is transmitted from the carrier terminal 40 to the delivery management server 10, information of the arrival parcel location that is a place where the carrier delivers the parcel is displayed on the screen of the carrier terminal 40 from the delivery management server 10. Therefore, the carrier 4 can deliver the parcel without hindrance. Further, in the case where delivery of a parcel is divided into a plurality of subsections and is delivered in a relay system by a plurality of carriers, the delivery destination of one subsection is disclosed only to a carrier who is in charge of such a subsection. Therefore, it is possible to conceal personal information such as delivery destinations of other subsections. Further, when the carrier ID included in the carrier start information does not coincide with the authorized carrier ID, information such as parcel delivery destination is not transmitted from the delivery management server 10 to the carrier terminal 40. Therefore, it is possible to conceal personal information such as a delivery destination from carriers other than the authorized carrier.

Further, according to the present embodiment, when the delivery management server 10 receives, from the carrier terminal 40, carrier start information or carrier end information configured of a random pattern image on a parcel and auxiliary information including the capturing place and the capturing date/time, the delivery management server 10 checks whether or not the received random pattern image and the random pattern image on the parcel, serving as the basis, match, and when they match, records the departure confirmation information or arrival confirmation information including the received random pattern image and the auxiliary data on the delivery schedule DB 145. Therefore, it is possible to acquire a confirmation that when and where the carrier 4 actually received the delivery object parcel and when and where the carrier 4 delivered it.

Further, according to the present embodiment, when the delivery management server 10 receives, from the receiver terminal 30, receipt information configured of a random pattern image on a parcel and auxiliary information including the capturing place and the capturing date/time, the delivery management server 10 checks whether or not the received random pattern image and the random pattern image on the parcel, serving as the basis, match, and when they match, records the receipt confirmation information including the received random pattern image and the auxiliary data on the delivery schedule DB 145. Therefore, it is possible to acquire confirmation that when and where the receiver 3 actually received the parcel.

Note that the above description is based on the premise that a delivery schedule created based on delivery request information is carried out without hindrance as originally scheduled at the time of creation. However, if an abnormal situation such as an accident of a carrier occurs, it is difficult to carry out the delivery schedule as originally scheduled. Therefore, the delivery schedule execution unit 155 of the delivery management server 10 may be configured that when it receives a notice indicating that the delivery becomes difficult from the carrier terminal 40 of any carrier 4, the delivery schedule execution unit 155 changes the delivery schedule of such a carrier 4 and the subsequent schedule in the delivery schedule DB 145 by using the delivery schedule creation unit 154. As a result, the carrier 4 and the storage place to be used are changed dynamically. However, since there is no label describing the delivery destination and the like on the parcel in the present embodiment, it is unnecessary to issue a new parcel label, so that it is possible to cope with an abnormal situation according to circumstances.

### Second Exemplary Embodiment

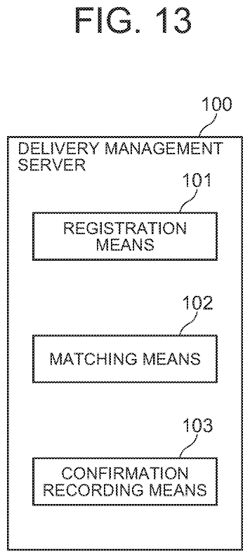

Next, a second exemplary embodiment of the present invention will be described with reference to the drawings. FIG. 13 is a block diagram of a delivery system according to the present embodiment.

Referring to FIG. 13, a delivery management server 100 according to the present embodiment is an information processing device connected to a user terminal that is used by a receiver who is a delivery destination of a delivery object or a carrier who delivers the delivery object, not illustrated, over a network, and is configured to include a registration means 101, a matching means 102, and a confirmation recording means 103.

The registration means 101 is configured to write identification information of a delivery object and a first image in which a random pattern on a surface of the delivery object is captured, into a storage means (not illustrated) in association with each other. The registration means 101 may be configured similarly to the delivery request reception unit 151 or/and the delivery schedule creation unit 154 of FIG. 2 for example, but is not limited thereto.

The matching means 102 is configured to perform matching between a second image in which a random pattern on a surface of the delivery object is captured, received from a carrier terminal, and the first image stored in the storage means. The matching means 102 may be configured similarly to the matching unit 156 of FIG. 2 for example, but is not limited thereto.

The confirmation recording means 103 is configured to, on the basis of a matching result of the matching means 102, record, on the storage means, the confirmation information giving a confirmation that the user of the user terminal received the delivery object that is identified by the identification information associated with the first image. The confirmation recording means 103 may be configured similarly to the delivery schedule execution unit 155 of FIG. 2 for example, but is not limited thereto.

The delivery management server 100 configured as described above operates as described below. The registration means 101 writes identification information of a delivery object and a first image in which a random pattern on a surface of the delivery object is captured, into a storage means in association with each other. Then, the matching means 102 performs matching between a second image in which a random pattern on a surface of the delivery object is captured, received from a carrier terminal, and the first image stored in the storage means. Then, on the basis of a matching result of the matching means 102, the confirmation recording means 103 records, on the storage means, confirmation information that gives a confirmation that the user of the user terminal received the delivery object that is identified by the identification information associated with the first image.

Since the delivery management server 100 according to the present embodiment is configured and operates as described above, it is possible to obtain a confirmation that a carrier or a receiver actually received the delivery object, simply and reliably. This is because since a pattern that is identical to the random pattern on the delivery object can be captured only by a person who is in contact with the delivery object, the user who transmitted such an identical pattern image must be a user who actually received the delivery object.

While the present invention has been described with reference to the exemplary embodiments described above, the present invention is not limited to the above-described embodiments. The form and details of the present invention can be changed within the scope of the present invention in various manners that can be understood by those skilled in the art.

For example, in the first exemplary embodiment, for each delivery request received from the sender terminal 20, the delivery schedule creation unit 154 of the delivery management server 10 may disclose the brief information of the delivery request on a website to recruit carriers. The brief information of a delivery request includes brief locations of the delivery source and the delivery destination and the size and weight of the parcel, but does not include details of the destination information, a random pattern image, and information such as random pattern position information. The carrier 4 accesses the website via the carrier terminal 40, and applies for a delivery request that he/she wishes to contract, while presenting the cost and the like. The delivery schedule creation unit 154 selects an actual carrier 4 from among the applicants based on the presented cost and the like. Then, the delivery schedule creation unit 154 creates a delivery schedule for the selected carrier 4. The procedure of carrying out the created delivery schedule by the delivery schedule execution unit 155 is the same as that described above. According to such a delivery management method, it is possible to realize a parcel delivery matching service without disclosing the details of destination information to the unspecified large number of persons.

### INDUSTRIAL APPLICABILITY

The present invention is applicable to the whole field of delivery in which a parcel and destination information such as a delivery destination are associated with each other.

The whole or part of the exemplary embodiments disclosed above can be described as, but not limited to, the following supplementary notes.

### (Supplementary Note 1)

A delivery management server connected to a user terminal over a network, the user terminal being used by a receiver who is a delivery destination of a delivery object or a carrier who delivers the delivery object, the server comprising:

registration means for writing identification information of the delivery object and a first image in which a random pattern on a surface of the delivery object is captured, into storage means in association with each other;

matching means for performing matching between a second image in which a random pattern on a surface of the delivery object is captured, received from the user terminal, and the first image stored in the storage means; and confirmation recording means for, on a basis of a result of the matching, recording, on the storage means, confirmation information that gives a confirmation that the user of the user terminal received the delivery object that is identified by the identification information associated with the first image.

### (Supplementary Note 2)

The delivery management server according to supplementary note 1, wherein the confirmation information includes the second image in which the matching succeeded.

### (Supplementary Note 3)

The delivery management server according to supplementary note 1 or 2, wherein the confirmation information includes information of a capturing location and capturing time that the second image was captured.

### (Supplementary Note 4)

The delivery management server according to any of supplementary notes 1 to 3, further comprising transmission means for transmitting information about a position of the random pattern on the delivery object to the user terminal.

### (Supplementary Note 5)

The delivery management server according to any of supplementary notes 1 to 4, wherein
the registration means is configured to detect an ellipse from the first image before writing the first image into the storage means, and perform projection transformation on the first image so as to allow the ellipse to be a circle.

### (Supplementary Note 6)

The delivery management server according to any of supplementary notes 1 to 5, wherein
the registration means is configured to calculate a matching score between the first image and an image having been stored in the storage means, before writing the first image into the storage means, and on a basis of the matching score, determine whether or not to write the first image into the storage means.

### (Supplementary Note 7)

A delivery management method to be executed by a delivery management server connected to a user terminal over a network, the user terminal being used by a receiver who is a delivery destination of a delivery object or a carrier who delivers the delivery object, the method comprising:
writing identification information of the delivery object and a first image in which a random pattern on a surface of the delivery object is captured, into storage means in association with each other;
performing matching between a second image in which a random pattern on a surface of the delivery object is captured, received from the user terminal, and the first image stored in the storage means; and
on a basis of a result of the matching, recording, on the storage means, confirmation information that gives a confirmation that the user of the user terminal received the delivery object that is identified by the identification information associated with the first image.

### (Supplementary Note 8)

The delivery management method according to supplementary note 7, wherein
the confirmation information includes the second image in which the matching succeeded.

### (Supplementary Note 9)

The delivery management method according to supplementary note 7 or 8, wherein
the confirmation information includes information of a capturing location and capturing time that the second image was captured.

### (Supplementary Note 10)

The delivery management method according to any of supplementary notes 7 to 9, further comprising
transmitting information about a position of the random pattern on the delivery object to the user terminal.

### (Supplementary Note 11)

The delivery management method according to any of supplementary notes 7 to 10, wherein
the writing includes detecting an ellipse from the first image before writing the first image into the storage means, and performing projection transformation on the first image so as to allow the ellipse to be a circle.

### (Supplementary Note 12)

The delivery management method according to any of supplementary notes 7 to 11, wherein
the writing includes calculating a matching score between the first image and an image having been stored in the storage means, before writing the first image into the storage means, and on a basis of the matching score, determining whether or not to write the first image into the storage means.

### (Supplementary Note 13)

A computer-readable medium storing thereon a program for causing a computer constituting a delivery management server connected to a user terminal over a network, the user terminal being used by a receiver who is a delivery destination of a delivery object or a carrier who delivers the delivery object, to execute processing to:
write identification information of the delivery object and a first image in which a random pattern on a surface of the delivery object is captured, into storage means in association with each other;
perform matching between a second image in which a random pattern on a surface of the delivery object is captured, received from the user terminal, and the first image stored in the storage means; and
on a basis of a result of the matching, record, on the storage means, confirmation information that gives a confirmation that the user of the user terminal received the delivery object that is identified by the identification information associated with the first image.

### (Supplementary Note 14)

A delivery system comprising the delivery management server according to any one of claims 1 to 6, and a sender terminal connected to the delivery management server over a network.

### REFERENCE SIGNS LIST

1 delivery system
2 sender
3 receiver
4 carrier
5 keeper
10 delivery management server
20 sender terminal
30 receiver terminal
40 carrier terminal
50 keeper terminal

What is claimed is:

1. A delivery management server connected to a user terminal over a network, the user terminal being used by a receiver who is a delivery destination of a delivery object or a carrier who delivers the delivery object, the server comprising:
a first memory containing program instructions; and
a processor coupled to the memory, wherein the processor is configured to execute the program instructions to:
write identification information of the delivery object and a first image in which a random pattern on a surface of the delivery object is captured, into a second memory in association with each other;
perform matching between a second image in which a random pattern on a surface of the delivery object is captured, received from the user terminal, and the first image stored in the second memory; and
on a basis of a result of the matching, record, on the second memory, confirmation information that gives a confirmation that the user of the user terminal received the delivery object that is identified by the identification information associated with the first image.

2. The delivery management server according to claim 1, wherein
the confirmation information includes the second image in which the matching succeeded.

3. The delivery management server according to claim 1, wherein
the confirmation information includes information of a capturing location and capturing time that the second image was captured.

4. The delivery management server according to claim 1, wherein the processor is further configured to execute the program instructions to
transmit information about a position of the random pattern on the delivery object to the user terminal.

5. The delivery management server according to claim 1, wherein the processor is further configured to execute the program instructions to
detect an ellipse from the first image before writing the first image into the second memory, and perform projection transformation on the first image so as to allow the ellipse to be a circle.

6. The delivery management server according to claim 1, wherein the processor is further configured to execute the program instructions to
calculate a matching score between the first image and an image having been stored in the second memory, before writing the first image into the second memory, and on a basis of the matching score, determine whether or not to write the first image into the second memory.

7. A delivery management method to be executed by a delivery management server connected to a user terminal over a network, the user terminal being used by a receiver who is a delivery destination of a delivery object or a carrier who delivers the delivery object, the method comprising:
writing identification information of the delivery object and a first image in which a random pattern on a surface of the delivery object is captured, into a memory in association with each other;
performing matching between a second image in which a random pattern on a surface of the delivery object is captured, received from the user terminal, and the first image stored in the memory; and
on a basis of a result of the matching, recording, on the memory, confirmation information that gives a confirmation that the user of the user terminal received the delivery object that is identified by the identification information associated with the first image.

8. The delivery management method according to claim 7, wherein
the confirmation information includes the second image in which the matching succeeded.

9. The delivery management method according to claim 7, wherein
the confirmation information includes information of a capturing location and capturing time that the second image was captured.

10. The delivery management method according to claim 7, further comprising
transmitting information about a position of the random pattern on the delivery object to the user terminal.

11. The delivery management method according to claim 7, wherein
the writing includes detecting an ellipse from the first image before writing the first image into the memory, and performing projection transformation on the first image so as to allow the ellipse to be a circle.

12. The delivery management method according to claim 7, wherein
the writing includes calculating a matching score between the first image and an image having been stored in the memory, before writing the first image into the memory, and on a basis of the matching score, determining whether or not to write the first image into the memory.

13. A non-transitory computer-readable medium storing thereon a program comprising instructions for causing a computer constituting a delivery management server connected to a user terminal over a network, the user terminal being used by a receiver who is a delivery destination of a delivery object or a carrier who delivers the delivery object, to execute processing to:
write identification information of the delivery object and a first image in which a random pattern on a surface of the delivery object is captured, into a memory in association with each other;
perform matching between a second image in which a random pattern on a surface of the delivery object is captured, received from the user terminal, and the first image stored in the memory; and
on a basis of a result of the matching, record, on the memory, storage means, confirmation information that gives a confirmation that the user of the user terminal received the delivery object that is identified by the identification information associated with the first image.

14. (canceled)
